(19) United States
(12) Patent Application Publication
(10) Pub. No.: US 2013/0306894 A1
(43) Pub. Date: Nov. 21, 2013

(54) VALVE

(71) Applicant: SVM Schultz Verwaltungs-GmbH & Co.KG, Memmingen (DE)

(72) Inventors: Johann Weiß, Wangen (DE); Ralph Wassermann, Memmingen (DE)

(21) Appl. No.: 13/895,730

(22) Filed: May 16, 2013

(30) Foreign Application Priority Data
May 16, 2012 (DE) 10 2012 104 285.3

(51) Int. Cl. F16K 31/06; F16K 25/00

(52) U.S. Cl. CPC F16K 31/0658; F16K 25/00
USPC 251/129.15; 251/337; 251/359

(57) ABSTRACT

The invention comprises a valve that can be operated by a drive, wherein the drive positions an adjustment element relatively to a nozzle for opening and closing the nozzle. On its side facing the nozzle, the adjustment element has a sealing element resting on the nozzle seat, when the valve is closed, and being lifted from the nozzle seat, when the valve is opened.

### CROSS REFERENCE TO RELATED APPLICATIONS

This application claims priority from German Patent Application No. 10 2012 104 285.3 filed on May 16, 2012, which is hereby incorporated by reference.

### FIELD OF THE INVENTION

The invention refers to a valve operated by a drive, wherein the drive positions an adjustment element relatively to a nozzle for opening and closing the nozzle, wherein the adjustment element has on its side facing the nozzle a sealing element resting on the nozzle seat, when the valve is closed, and is lifted from the nozzle seat, when the valve is opened.

### BACKGROUND OF THE INVENTION

Above-mentioned valves are very common in the state of the art. For example, electro-magnetically driven valves are known with an adjustment element that is connected in one piece with the armature of the solenoid, or is in direct operative connection therewith. The adjustment element itself has on its front end facing the nozzle a cage-like receiver in which the sealing element is inserted moving freely and unguided relative to the adjustment element.

The movement of the drive moves the adjustment element; this can be, for example, a longitudinal, a rotational, or a folding movement. This movement serves for putting the sealing element in a suitable way on the nozzle seat, and to lift it again therefrom, and thus creating an opening or closing position of the valve. It is clear that the adjustment element has appropriate recesses or openings so that the often interior sealing element can get in operative connection with the nozzle seat.

Valves of this type operate in a large temperature range, for example from −40° to +140°. The sealing element often consists of an elastomer with another coefficient of expansion than the material of the adjustment element. Here the risk arises that the usually provided clearance fit only works in a narrow temperature range, and in another temperature range the result will be a jamming of the sealing element relative to the adjustment element thus interfering with the safe closing and opening function of the valve.

Therefore, a larger fit between the sealing element and its guide at the adjustment element has been suggested as a possible solution, that basically allows an operation in a larger temperature interval, but also bears the risk of the sealing element being prone to tilting. What arises is even another problem, namely that the sealing element does not always rest on the same spot with respect to the nozzle seat, but shifted to the side or radially. The elastic material has an in particular temperature-dependent re-adjusting property that is often worse with low temperatures. Proof for this is that the period of time required for a complete relaxation of the sealing element compressed on the nozzle seat is longer than the average cycle time between two closing positions of the valve. This means that in these cases the not yet completely relaxed sealing element is already pressed on the nozzle seat in the next closing step of the valve.

If there is a large radial clearance of the sealing element in the adjustment element, there is a risk that the sealing element will get radially, shifted laterally on the nozzle seat leading straight to leakage in the valve. It is clear that this interferes massively with the expected function of the valve.

### BRIEF SUMMARY OF THE INVENTION

Referring to this state of the art it is a problem of the present invention to suggest a valve that is as reliable in operation as possible.

Referring to the before-described valve, the invention suggests for solving the above-mentioned problem that the sealing element is supported on bearings via a spring element at the adjustment element and is movable relative thereto. The known sealing element is, according to the invention, connected with a separate spring element, the spring element resting the sealing element at the adjustment element and allowing a corresponding (defined) mobility relative to the adjustment element. The supporting function of the spring element surprisingly achieves that the valves according to the invention have a much higher reliability as the sealing element does not shift laterally or radially relative to the nozzle seat—at no matter level of temperature—, and thus the reliability of the valve does not depend on the temperature-dependent resilience of the elastomer of the sealing element anymore.

However, surprisingly, even a number of other advantages can be achieved by the suggestion according to the invention.

The guide of the sealing element via the separate spring element, as suggested by the invention, has the result that the sealing element is no more in contact with the side walls of the cage-like configured holding space, and can rub and wear there, as it has been observed in the state of the art. The wear of the outer surface of the often cylindrical sealing element (the front face is for sealing) may not yet interfere immediately with the sealing function of the sealing element, however limits to a considerable extent the longtime stability of the valve.

In the state of the art, the problem of the guide of the elastomer in the adjustment element was dealt with by using an appropriate guide sleeve with suitable material properties. This very expensive working step is avoided by the suggestion according to the invention.

The support on bearings of the sealing element via the spring element also effectively counteracts an imminent tilting of the sealing element, and raises the reliability of the valve according to the invention considerably.

Separating the functions mobility and sealing in, on the one hand, the spring element and, on the other hand, the sealing element also allows optimizing these two functions appropriately independently from one another. The suggestion according to the invention thus allows to dimension the spring element independently from the material properties of the elastomer of the sealing element such that a perfect interaction of the sealing element with the movement of the adjustment element is the result. This can be used in the opened as well as in the closed position of the valve, and is of advantage.

A result of the suggestion according to the invention is, for example, an improved permanence of the values of the flow rate of the medium flowing through the valves as the (axial as well as radial) position of the sealing element can be exactly predefined because of the spring element and also be kept permanent, i. e. it is reproducible.

Thus, the suggestion according to the invention does not only solve the problem set out in the beginning, but surprisingly shows a multitude of other advantages.

An improvement of the suggestion provides that the adjustment element has a tappet that, at least during lifting the sealing element from the nozzle seat, is in contact with the sealing element. As described, it is provided that the sealing element is movable toward the adjustment element. This is eventually restricted by the spring travel or the stroke of the spring element. When the sealing element rests on the nozzle seat, usually adhering or sticking can be observed, so that it is advantageous to impress a separate lifting force on the sealing element. This lifting force would load the spring element, if no other provisions are made, so that the use of a separate tappet is here a corresponding advantage, as, on the one hand—exactly controlled by the position of the tappet relatively to the sealing element—the time of peeling the sealing element away from the nozzle seat can be defined, and, on the other hand, the spring element is protected from being excessively loaded.

Preferably, the tappet is arranged preferably rigidly at the adjustment element and moves along with it. Therefore, the sealing element is also movable relative to the tappet. Just during the peeling movement, the tappet is not yet in contact with the sealing element, but overcomes first a certain distance in order to act then on the sealing element.

The tappet can be configured here as contact collar that is in contact with the sealing element on the side facing the nozzle seat. However, there is also the option of the sealing element having a circumferential groove, and the tappet or contact collar projecting in this circumferential groove located in the outer surface, and being in contact there with the groove wall during the peeling movement and pulling the sealing element along. Different modifications are possible here how the tappet is arranged and designed relatively to the sealing element. The invention is not restricted thereto.

The invention can be designed also very highly variable with respect to the configuration of the contact collar. Thus, it is provided, for example, that the contact collar is configured annularly, point-like or segment-like, or interacts contacting the sealing element in sections. Of course, it is possible that the contact collar or tappet is in contact with the nozzle on the side of the sealing element facing the nozzle.

Another variant according to the invention provides that the adjustment element has on the side facing the nozzle an at least partly opened cover cap forming the tappet and at least partly covering the sealing element. Therefore, the cover cap can take over a multitude of functions. On the one hand, it seals the holding space holding the sealing element cage-like. Thus, it also forms a protection for the sealing element. The preferably front-side opening, that cleverly does not collide with the nozzle seat, guarantees the interaction of the sealing element with the nozzle or the nozzle seat. This opening is described, for example, as recess. The edge of the recess is designed here, for example, as annular contact collar.

In another improvement of this suggestion it is provided that the cover cap at least partly seals a holding space of the adjustment element, the holding space holds the sealing element, and the cover cap has at least one opening through which the holding space can be vented when the valve is in closed position.

The cover cap can also be configured such that there is no restriction or end of the holding space.

Valves of this species are employed, for example, for controlling flowing media in the field of pneumatics or, if necessary, also in hydraulics. A complete ventilation of the area around the sealing element makes operating the valve easier and saves energy. When the valve is closed, the adjustment element (either by its drive or a return spring or the like) presses the sealing element snuggly to the nozzle seat. The arrangement of corresponding openings allowing airing or ventilating of the holding space just when the valve is closed, reduces the adhesion effect that may occur just when the valve is opened.

The construction of the adjustment element is here such that it forms, for example, at least the side walls of the holding space, although this can also be configured differently, according to the invention. The sealing element arranged on the spring element is then positioned on the area facing the nozzle, and is covered by the slid-on cover cap.

The cover cap itself can be configured, for example, like a disc or pot, and be connected or held laterally on the adjustment element. In this case, the holding space is formed primarily by the cover cap, the front face of the adjustment element seals this space. Different modifications are possible for realizing the holding space. In the holding space, the spring element is arranged along with the sealing element, and the cover cap has to be fastened to the adjustment element in a suitable way, for example, a one-piece design of the cover cap along with the adjustment element being one option. This is realized, for example, by an appropriate forming machining step where a sleeve is bent or compressed inwards.

Besides this one-piece configuration of the cover cap along with the adjustment element, also a connection by welding or soldering or soldering the cover cap on the adjustment element is possible. Also a material connection, for example by a glue layer, that is gluing, is comprised by the invention as well as also mechanic, that means force-fitting or form-fitting ways of connecting, such as caulking, flanging, clamping or clipping.

Cleverly, here a way of connection is chosen that does not only reliably fasten the cover cap to the adjustment element, but at the same time, fixes the spring element at the adjustment element as intended.

In a preferred development of the suggestion it is provided that the sealing element has a penetration opening that runs, on the one hand, in the nozzle, and, on the other hand, forms a servo valve facing the adjustment element, and the servo valve is sealed by the sealing surface of the adjustment facing the sealing element, when the valve is closed.

The concept of a servo valve reduces the force required for opening the closed valve what has a positive effect on the construction of the drive. The way of function is described and shown in detail in particular in the enclosed figure. Usually, the penetration opening in the sealing element is axially parallel to the axis defined by the nozzle. However, the invention is not restricted thereto, the penetration opening can also run diagonally. The configuration of the penetration opening according to the invention is also very variable, a bore hole, that is a cylindrical penetration opening, can be provided, as well as a cone shape or intermediate shape thereof. The knack, when employing a servo valve, is the fact that the sealing element is used multiple for sealing functions, namely, on the one hand, for closing or releasing the (main) nozzle, and, on the other hand, it forms itself a nozzle that can be closed by the bottom or sealing surface of the adjustment element facing the sealing element. Advantageously, the elasticity of the material of the sealing element is used double for the sealing function.

Cleverly, the effective diameter of the servo nozzle is here less than the diameter of the (main) nozzle.

At the adjustment element facing the sealing element the sealing surface is provided. Usually, this is the front face of the adjustment element facing the nozzle, however, the invention is not restricted to it. In the construction, this can also be taken over by another side or surface of the adjustment element. In the closed position of the valve a deforming seal ring or sealing bead is arranged at the sealing element surrounding the sealing surface of the servo nozzle and consisting of elastic material. This seal ring or sealing bead projects beyond the sealing surface in the direction of the sealing element, and effects on the side or radially next to it a corresponding free positioning or undercut that is pressure-balanced with the other pressure potential on that side of the valve or the sealing element. The result is here that the same operative pressure is connected to the servo nozzle and its cross section surface as to the main nozzle, so that opening the servo nozzle requires low opening force. This is exactly the concept of the servo nozzle.

It has to be stated that the concept of free positioning can even be realized in another way, for example by means of an accordingly configured sealing element forming on the side of the penetration opening facing the sealing surface a separate sealing edge, seal ring or sealing bead from elastic material of the sealing element. The result will be the same.

Preferably, the spring element is from two-dimensional elastic material, such as, for example, spring steel. It is optimized in a suitable way for the elastic function, adjusting and moving, the sealing element respectively. Also the choice of the material of the spring element is a part of it.

The spring element effects a guide of the sealing element at the adjustment element, radially with respect to the nozzle seat and in particular friction-free. The phrasing “at the adjustment element”, of course, includes here a configuration of the guide of the sealing element at the adjustment element. The suggestion according to the invention reliably avoids, on the one hand, an extensive wear of the sealing element by lateral contact and rubbing at the adjustment element and its holding space, respectively, on the other hand, the arrangement of the spring element achieves an exact, in particular also exactly repeatable positioning of the sealing element on the nozzle seat.

For fastening the sealing element on the spring element a multitude of different concepts are possible, the invention is not concluded here. Thus, the sealing element can be sprayed on, buttoned into, clipped on, vulcanized on, or glued to the spring element. Each connection technique is comprised by the invention that is suited for the spring element carrying the sealing element preferably permanently.

It has already been pointed out that the sealing element is formed preferably as elastomer; for example, it is possible to form the sealing element from rather soft material, for example, with at least 60 Shore A, or basically to employ also elastomers with a Shore-hardness less than 80 Shore A or 85 Shore A. This is possible as the guide of the sealing element on the spring element leads to an accordingly sparing use of the sealing element, and therefore the sealing element can be perfected for the sealing function. This is, of course, very effective when using soft material.

Furthermore, on the sealing element preferably on the side facing the nozzle a circular groove acting in particular as free positioning is provided. This circular groove or free positioning effects that, when the sealing element is in contact with the nozzle seat, there is no notch effect in the sealing element. The arrangement is here chosen such that at the material, seen from outside inwards, the outer area of the sealing element (facing the nozzle) interacts with the tappet during the opening or retraction movement of the adjustment element, and thus is caught by it. Radially inwards then the before described circular groove as free positioning joins this area that then merges in the sealing element area closing or sealing the nozzle seat or the nozzle.

Another advantage of the employment of the spring element carrying the sealing element is the fact that, depending on the construction, the spring element can show a pre-tension, and thus the unloaded position of the sealing element can be unambiguously defined in the valve according to the invention. The pre-tension can here effect corresponding presettings in different directions, what is an advantage. In particular, a two-dimensional configuration of the spring element is provided allowing, coming from an unloaded center position, a pre-tension in two directions (rectangular to the two-dimensional configuration of the spring element). In this case, both pre-tension directions (e. g. in the direction of the adjustment element or away from it) are available. Of course, it is also possible that no pre-tension acts on the spring element.

In a preferred embodiment of the spring element, its elastic quality derives from an elastic deformation of its two-dimensional configuration. This can be achieved, for example, by configuring the spring element as meander spring, disc spring, star spring, or leaf spring. This configuration realizes a very space-saving arrangement, wherein it is, in particular, an advantage here that the required stroke of the spring element in the valve according to the invention is not very large.

It has to be stated that, of course, also other embodiments of the spring element, such as, for example, a conical spring or even a coil spring or other springs can be provided.

The spring element can be subdivided in a holding area and a spring area, the sealing element being arranged in the (central) holding area. This subdivision avoids an extensive mechanic stress of the sealing element, what is achieved, for example, by an appropriate variation of the stiffness of the spring element in the holding area in relation to the spring area.

Cleverly, in the spring area at least one penetration opening is provided. It serves for ventilating the servo nozzle area, and, at the same time, as filter or element retaining dirt particles that may be present in the medium to be controlled. Elements of this kind can render the servo nozzle useless, and thus lead to a failure of the entire valve. The configuration of the penetration opening in the spring area makes it possible to adjust the “filter size” without any problems.

The spring element carrying the sealing element is preferably arranged between cover cap and adjustment element, or provided in the holding space limited by cover cap and adjustment element. Of course, for a reliable guide of the sealing element it is also provided that the spring element is appropriately fixed to the adjustment element, what can be realized, for example, along with the fixing of the cover cap, or independently therefrom, for example by a separate fastening step before the cover cap is put on and fastened. The spring element can be, for example, welded with, glued on, caulked on, flanged on, soldered on, clipped on the adjustment element, or be connected in another way mechanically or through material.

Cleverly, an essential parallel effective direction of the spring element and the adjustment or retraction movement of the adjustment element is provided. The parallelism of the directions makes the interaction of the elements considerably easier, although also differing concepts are comprised by the invention, for example, when the adjustment element and/or the sealing element each are guided on an arched track or a circular track. These concepts are also enclosed in the idea according to the invention.

In a preferred embodiment of the invention, a solenoid is provided as drive, the solenoid having a coil that can be electrified, and a movably supported armature being movable, in particular against the power of a return spring, and the armature moving the adjustment element, or the armature forming the adjustment element. The employment of a solenoid as drive of the valve according to the invention is a preferred of several different alternative drive concepts. The adjustment element carrying out the movement can be in one piece with the armature moved by the coil of the solenoid, or it can be provided or supported on bearings separately therefrom. Then an appropriate mechanic coupling is provided between armature and adjustment element.

Of course, the invention also comprises solutions where the retraction movement is realized not by a return spring, but by an also electro-magnetically produced motion impulse.

Neither is the invention aimed at an exclusively straight movement of the adjustment element in the valve according to the invention, but comprises for example also a rotational or folding movement of the adjustment element, that is the movement that is suited for lifting the sealing element safely and reliably reproducible on the seal seat and lift it again away from it. A straight concept of the movement of the armature element has, of course, appropriate advantages during the movement, however, the use of the spring element allows providing, for example, a rotational or folding movement of the adjustment element in the area of the nozzle seat and a corresponding balance by a suitable pre-tension of the spring element.

### BRIEF DESCRIPTION OF THE SEVERAL VIEWS OF THE DRAWINGS

In the drawing the invention is shown schematically in an embodiment. In the figures:

FIGS. 1a, 1b, and 1c illustrate in sectional views the valve according to the invention in three different positions, namely in the completely closed position (FIG. 1a), with opened servo nozzle (FIG. 1b), and completely opened (FIG. 1c);

FIGS. 2a, 2b, 2c, 2d, 2e, 2f illustrate in three-dimensional views different embodiments of a spring element with sealing element arranged thereon, usable in the valve according to the invention.

In the figures, identical or corresponding elements each are referred to by the same reference numbers, and therefore are, if not useful, not described anew.

### DETAILED DESCRIPTION OF THE PREFERRED EMBODIMENTS

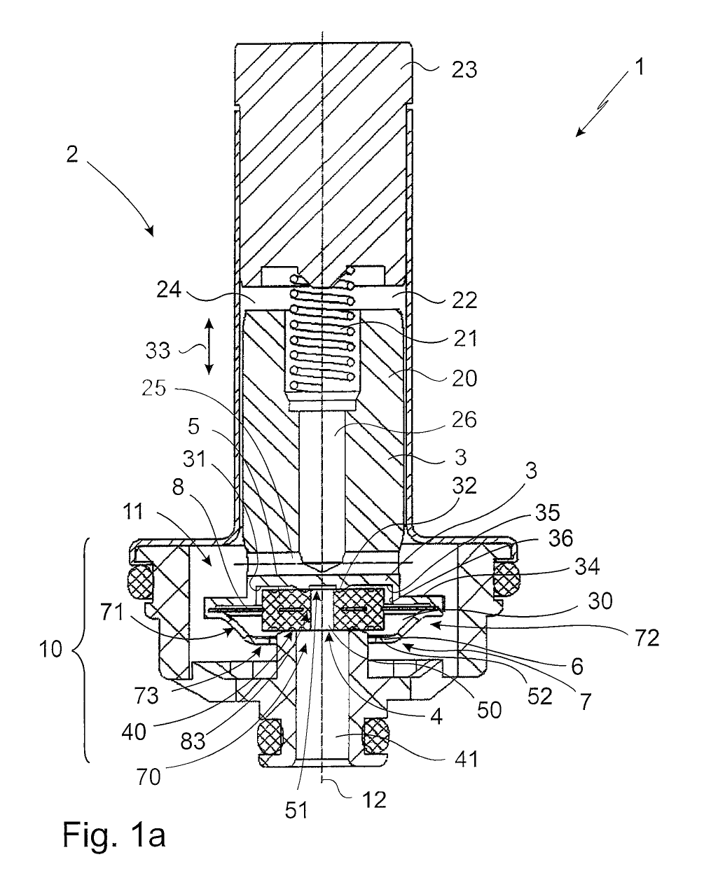

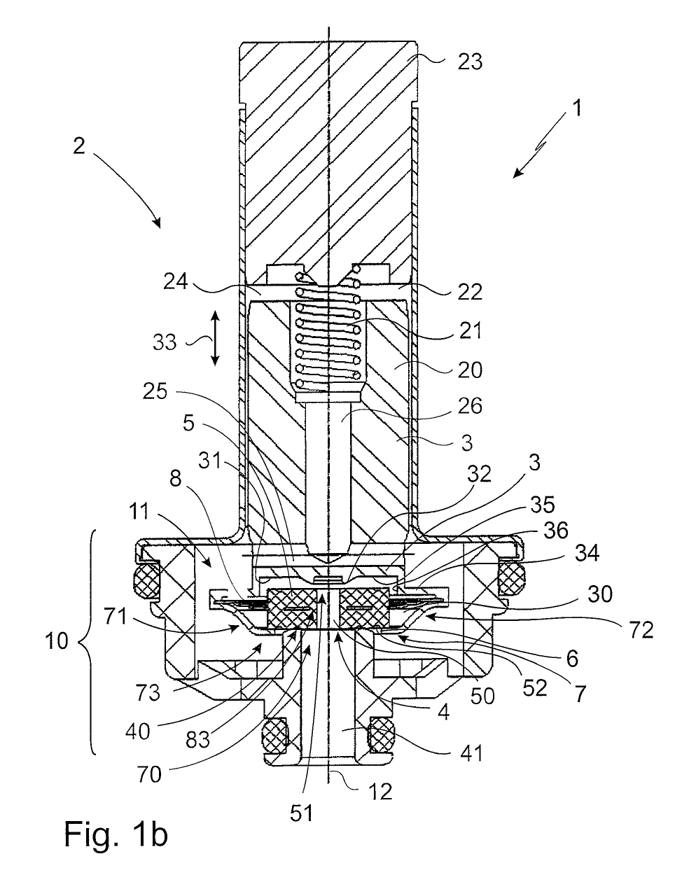

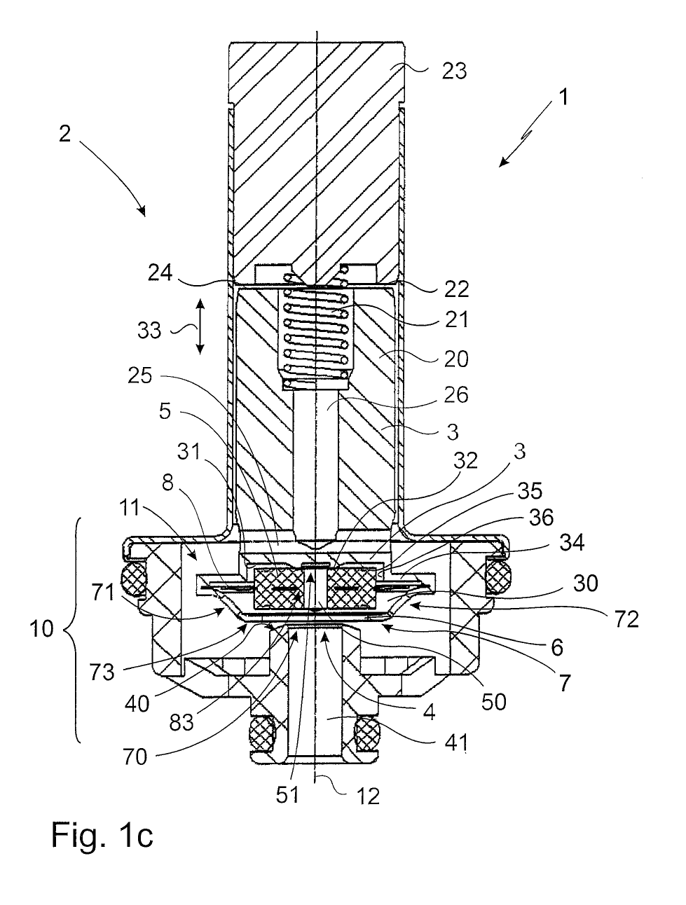

FIG. 1a shows the valve 1 according to the invention in the closed position. The valve has a valve part 10 as well as a drive 2 that is not completed in the chosen views. The drive 2, for example, is realized as solenoid having a coil (not shown) that can be electrified in the usual way, and a movably supported armature 20 that can be moved by electrifying, in particular against the power of a return spring 21.

The armature 20 itself acts on the adjustment element 3 that is already part of the valve part 10 and projects in the valve space 11, and carries out the movement generated by the armature 20 in a closing and opening movement. As already described, armature 20 and adjustment element 3 can be two separate components or one (common) component with two functions, that means the armature 20 forms the adjustment element 3. The latter modification is shown.

The armature 20 is supported movably on bearings in the armature space 22 in a well-known way, the direction of movement is indicated by the double arrow 33 that corresponds at the same time the direction of movement of the adjustment element 3. On the side of the armature space 22 or the armature 20 opposite the adjustment element 3 or the valve part 10, after an air gap 24 the core or magnetic core 23 joins that is, as stationary part, a component of the solenoid and conducts magnetic field lines. The dropped position of the solenoid shown in FIG. 1a shows that the air gap 24 (in the armature space 22) occurring between armature 20 and magnetic core 23 has largest extension here. The armature 20 and thus also the adjustment element 3 is supported via the return spring 21 by the core, and (in the view shown here) pushed downwards so that the sealing element supported in or at the adjustment element 3 rests with its entire surface on the nozzle seat 40 of the nozzle 4. In currentless condition, this valve is closed. However, the concept according to the invention also works when the valves are currentless open.

The armature space 22 is connected pressure-balanced through an axial bore hole 26 and a diagonal bore hole 25 with the valve space 11 in order to allow thus pressure balance or ventilation during the movement of the armature and thus to allow a movement of the armature 20.

A valve space 11 is provided in the valve part 10 that is in operative connection with a pressure port 41. The nozzle 4 is opened and closed by a sealing element 5, depending on the position of the adjustment element 3. The pressure port 41 is connected to the nozzle 4, for example in the direction of a working port.

The adjustment element 3 carries on its side facing the nozzle 4 the sealing element 5. For this, on the side of the adjustment element 3 facing the nozzle 4 a holding space 30 is provided in which the sealing element 5 is guided movably essentially parallel to the direction of movement 33 of the adjustment element 3/the armature 20.

Cleverly and according to the invention, here the sealing element 5 is restricted with respect to its free movement in the holding space 30.

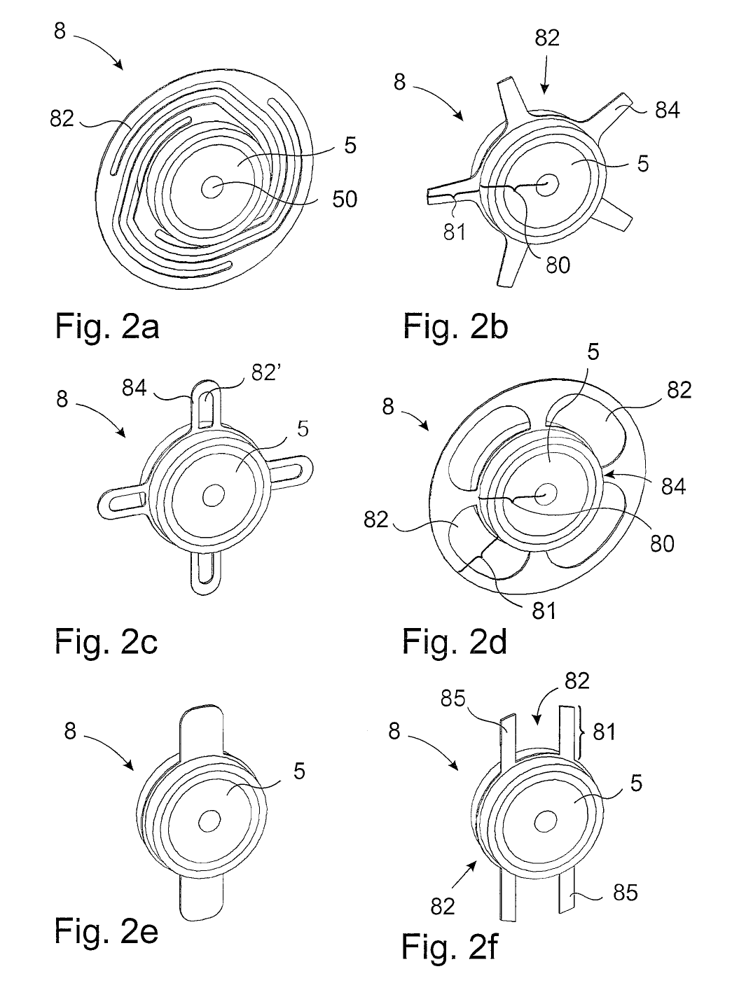

The resulting guide of the sealing element 5 has some advantages, as described. By providing a spring element 8 that is fixed in a suitable way at the adjustment element 3 and carries preferably in the middle or symmetrically or centered the sealing element 5, this guide is achieved. There is a multitude of different modifications for configuring the spring element 8, as they will be described, for example, in FIGS. 2a-2f. In the embodiment shown here, for example, the sealing element 5 is sprayed on in the middle area of the spring element 8 described as holding area 80, wherein in this area the spring element 8 has appropriate recesses 83 through which the (elastic) material of the sealing element 5 that can be sprayed penetrates and forms an in particular form-fitting connection with the spring element 8.

The spring element 8 allows a mobility of the sealing element in a direction of movement parallel to the movement 33 of the adjustment element 3.

For this, the spring element 8 is connected on its outer edge with the adjustment element 3. The adjustment 3 has in this area a radially (with respect to the direction of movement 33 or the center axis 12) outwards pointing, flange-like ring 34 forming a contact or connection surface for the spring element 8. This ring 34 projects here beyond the diameter of the armature 20 in the valve space 11.

The spring element 8 and the sealing element 5 are arranged in the holding space 13 and thus guided and also protected. The holding space 30 is limited by the front face 35 of the adjustment element 3, a cylinder-shaped edge 36 joining the front face 35 and merging in the ring 34, as well as a cover cap 7 joining the ring 34 disc- or pot-like, and running in the direction of the nozzle 4 therefrom.

Said cover cap 7 has several functions. For example, it seals the holding space 30. The fact that the cover cap 7 has, for example, openings 71 or recesses 70 does not contradict this. The cover cap 7, for example, is carried out in one piece at the ring 34 as part of the adjustment element 3, or is carried out and fastened fixedly as separate part, for example lased-on, welded-on, glued-on, soldered-on or in another, mechanic (e. g. caulked-on etc) way, as already described.

The cover cap 7 is, for example, rotational symmetric with respect to the center axis 12. The center area, indicated as bottom 73, extends essentially plane, the cover cap 7 has on its edges an edge 72 upward-folded in the direction of the adjustment element, the edge 72 running in the connection area for joining the cover cap 7 with the adjustment element 3.

On the bottom 73 of the cover cap 7 a recess 70 is provided, dimensioned such that the cover cap 7 does not collide with the nozzle 4 in the bottom area 73.

The arrangement of the recess 70 allows that the sealing element 5 can be put snugly on the nozzle seat 40 of the nozzle 4. Thus, it can be seen clearly in FIG. 1a that the bottom 73 is slid laterally, next to the recess 70, on the nozzle 4. Of course, the arrangement is chosen such that there are only very small gaps or free motion.

In the embodiment shown here, the valve 1 is equipped with a servo nozzle 51. This is realized in the sealing element 5 such that it has a penetration opening 50 running preferably parallel to the center axis 12. This penetration opening 50 runs on the sides opposite the adjustment element 3 in the nozzle 4, and is sealed on the side facing the adjustment element 3 by a sealing surface 31. In the example shown here, this sealing surface 31 is identical with the front face 35 of the adjustment element 3.

It can be seen clearly that on the sealing surface 31 in the direction of the sealing element 5 in the area of the servo nozzle 51 a seal ring 32 projects pressing in the elastic material of the sealing element 5 because the valve 1 is closed. However, the seal ring 32 thus also defines the sealing surface effective here, and thus the closing power that has to be overcome in an opening step; it is clear that this sealing surface is clearly smaller than the sealing surface at the nozzle seat 40. What is the “knack” now with the servo nozzle is the fact that the required forces for opening the valve are thus reduced, and a smaller (electro-magnetic) drive is sufficient for operating the valve.

The area radially, laterally next to the seal ring 32 is here pressure-balanced with the rest of the interior of the valve, the valve space 11. Even in the closed position of the valve 1, this pressure balance is performed via the opening 71 provided in the lateral edge 72 of the cover cap 7, and through recesses 83 in the spring element 8 through which the area of the holding space 30 facing the front face 35 of the adjustment element 3 is pressure-balanced.

Now the opening motion of the valve, that has been completely closed in FIG. 1a and completely opened in FIG. 1c, will be described here briefly.

Main nozzle 4 and servo nozzle 51 are closed, the adjustment element 3 is shifted in the direction of the nozzle 4 by the return spring 21, the solenoid is currentless. Referring to this closed position, the drive 2 is activated, for example, the not-shown coil of the solenoid is electrified, so that between the armature 20 and the air gap provided in the magnetic core 23 (against the power of the return spring 21) a constellation of the magnetic field lines results that tries to draw the armature 20 in the direction of the magnetic core 23. This upwards directed movement of the armature 20 leads to a lifting movement of the adjustment element 3 relatively to the nozzle 4, wherein first the servo nozzle 51 is opened, that means, the sealing surface 31 recedes upwards, and the sealing ring 32 emerges from the compressed material of the sealing element 5, so that the servo nozzle 51 is opened. Otherwise, the sealing element 5 remains resting on the nozzle 4.

The pressure to be controlled is connected in the valve space 11, which is, as a rule, the downstream volume at lower pressure than the outlet 41 of the nozzle 4, thus also the working pressure is connected with the sealing ring 32 of the servo nozzle 51, and the power necessary for opening the servo nozzle results then from the product of the effective sealing surface and the pressure difference between the valve space 11 and the nozzle outlet 41. Thus then a pre-flooding of the nozzle outlet 41 is performed, and thus a reduction of the pressure difference between the nozzle outlet 41 and the valve space 11, so that the necessary force for lifting the sealing element 5 from the nozzle seat 40 (with larger sealing surface) is reduced.

FIG. 1b shows the opened servo nozzle 51, it can also be seen clearly in FIG. 1b that the annular area of the cover cap 7 joining the recess 70 is in contact with the area of the sealing element 5 facing the nozzle 4. The edge surrounding the recess 70 forms a tappet 6 that now, in the situation shown in FIG. 1b, starts acting, namely the tappet 6 is in contact with the sealing element 5 during another retraction movement of the adjustment element 3 (reduction of the air gap 24), and lifts it from the nozzle seat 40. This is carried out without additional mechanic stress of the spring element 8 and of the valve 1, and it reaches the position, as shown in FIG. 1c, the air gap 24 is very small, the nozzle 4 is completely opened, the cover cap 7 is lifted above the nozzle 4.

The arrangement is here chosen such that in the opened position the servo nozzle 51 is closed again, so that the sealing element 5 in the opened position takes a defined position, and thus also the flow gap at the nozzle 4 is defined exactly reproducibly. This can be realized by the appropriate dimensioning of the pre-tension of the spring element 8, for example, without any problems. However, also other options of pre-tension are possible according to the invention.

The sealing element 5 has on its side facing the nozzle 4 a circular groove 52 acting as free positioning with regard to the tappet 6. The tappet 6, here the inner edge of the recess 70 in the bottom 73 of the cover cap 7, is here in contact on the radially outside the circular groove 52 provided area of the sealing element 5 when the tappet 6 interacts with the sealing element 5. The circular groove 52 counteracts effectively an imminent forming of notches because of the interaction of the radial exterior area of the sealing element 5 with the tappet 6.

FIGS. 2a to 2f show a multitude of different embodiments of the spring element 8 carrying the sealing element 5.

FIG. 2a, for example, shows the configuration with a meander spring where spiral penetration openings 82 join spirally running elastic material webs or bridges 85. The spring travel is here defined, in particular, by the length of this material bridges 85. At the same time, the penetration opening 82 also causes a pressure compensation for the front and back side of the spring element otherwise inserted closely in the cover cap 7 or swell element 3.

For a better orientation in the spring element, in FIG. 2b the holding area 80 is shown separately from the spring area 81. The spring area 81 is located radially outside, and takes over primarily (preferably exclusively) the elastic property of the spring element 8. The holding area 80 serves for holding and fastening the sealing element 5. In FIG. 2b, radial beams 84 are provided forming the spring area 81; the penetration openings 82, open on one side, however, of course, everywhere encircled when built in, extend between them.

FIG. 2c shows a construction similar to FIG. 2b, the fastening beams 84 are here arranged cross-like and form the penetration openings 82′.

FIG. 2d shows a spring element formed disc-like, similar to the “meander spring” modification of FIG. 2a, however, also with essentially radially extending, elastic beams 84 widening in the radial outer area and thus forming the four penetration openings 82, that have identical size and are arranged equidistantly, in the circumferential direction of the spring element 8.

FIG. 2e shows a two-side opposite supported configuration of the spring element 8 that is even more simplified in FIG. 2f by arranging only four rods 85 H-like and carrying between them the sealing element 5.

Although the invention has been described in terms of specific embodiments which are set forth in considerable detail, it should be understood that this is by way of illustration only, and that the invention is not limited necessarily thereto, since alternative embodiments and operating techniques will become apparent to those skilled in the art in view of the disclosure. Accordingly, modifications are contemplated which can be made without departing from the spirit of the described invention.

What is claimed is:

1. A valve operated by a drive, wherein the drive positions an adjustment element relatively to a nozzle for opening and closing the nozzle, wherein the adjustment element has on its side facing the nozzle a sealing element that rests, in the closed position of the valve, on the nozzle seat, and, in the opened position of the valve, is lifted from the nozzle seat, wherein the sealing element is supported on bearings via a spring element at the adjustment element and is movable relatively thereto.

2. The valve according to claim 1, wherein the adjustment element has a tappet, and the tappet is in contact with the sealing element, at least when the sealing element is lifted from the nozzle seat.

3. The valve according to claim 1, wherein the adjustment element has a tappet, and the tappet is in contact with the sealing element, at least when the sealing element is lifted from the nozzle seat, and the tappet is configured as contact collar that is in contact, in particular annularly, point-like, segment-like, or in sections, with the sealing element on the side facing the nozzle seat when the sealing element is lifted.

4. The valve according to claim 1, wherein the adjustment element has a tappet, and the adjustment element has on the side facing the nozzle an at least partly opened cover cap forming the tappet and at least partly covering the sealing element.

5. The valve according to claim 1, wherein the adjustment element has a holding space and a tappet, and the adjustment element has on the side facing the nozzle an at least partly opened cover cap forming the tappet, at least partly covering the sealing element and having a recess in the area of the nozzle, and with the cover cap at least partly sealing the holding space at least partly, and the holding space holding the sealing element, and the cover cap having at least one opening through which the holding space can be vented when the valve is in closed position.

6. The valve according to claim 1, wherein the adjustment element has a tappet, and the tappet has on the side facing the nozzle an at least partly opened cover cap forming the tappet and at least partly covering the sealing element, wherein the cover cap is arranged at the adjustment element either in one piece, welded on, glued on, snapped on, clipped on, caulked, flanged on, or soldered on.

7. The valve according to claim 1, wherein the adjustment element has a tappet, and the adjustment element has on the side facing the nozzle an at least partly opened cover cap forming the tappet and at least partly covering the sealing element, wherein the cover cap and the adjustment element consist of the same or different material.

8. The valve according to claim 1, wherein the adjustment element has a sealing surface and the sealing element has a penetration opening, and the penetration opening runs, on the one hand, in the nozzle, and forms, on the other hand, facing the adjustment element a servo valve, with in the closed position of the valve, the servo valve being sealed by the sealing surface of the adjustment element facing the sealing element.

9. The valve according to claim 1, wherein the adjustment element has a sealing surface, and the sealing element has a penetration opening, and the penetration opening runs, on the one hand, in the nozzle, and forms, on the other hand, facing the adjustment element a servo valve, and wherein the sealing surface has a seal ring or sealing bead surrounding the servo valve and deforming in the closed position the sealing element consisting of elastic material.

10. The valve according to claim 1, wherein the adjustment element has a tappet, and performs a retraction movement, and wherein, coming from the closed position, the retraction movement of the adjustment element first opens the servo valve, with the adjustment element being moved relatively to the sealing element resting on the nozzle seat, and wherein, during another retraction movement, the tappet lifts the sealing element from the nozzle seat.

11. The valve according to claim 1, wherein the spring element effects a guide of the sealing element radially with respect to the nozzle seat and in particular frictionless at or in the adjustment element.

12. The valve according to claim 1, wherein the spring element is formed from two-dimensional elastic material, for example spring steel.

13. The valve according to claim 1, wherein the spring element carries the sealing element, and wherein the sealing element is either sprayed on, buttoned into, clipped on, vulcanized on or glued to the spring element.

14. The valve according to claim 1, wherein the sealing element has on the side facing the nozzle a circular groove in particular acting as free positioning.

15. The valve according to claim 1, wherein the spring element is configured as meander spring, disc spring, star spring, or leaf spring, and wherein the spring element has a holding area and a spring area, with the sealing element being arranged in the holding area.

16. The valve according to claim 1, wherein the spring element is configured as meander spring, disc spring, star spring, or leaf spring, and wherein the spring element has a holding area and a spring area, and wherein in the spring area at least one penetration opening is provided.

17. The valve according to claim 1, wherein the adjustment element has a holding space and a tappet, and the adjustment element has on the side facing the nozzle an at least partly opened cover cap forming the tappet, covering the sealing element at least partly, and having a recess in the area of the nozzle, with the spring element being arranged between cover cap and adjustment element, wherein the spring element is preferably either welded with, glued on, caulked, flanged on, or soldered on the adjustment element.

18. The valve according to claim 1, wherein the spring element and the adjustment and/or retraction movement of the adjustment element have an effective direction, and wherein the effective direction of the spring element and the adjustment and/or retraction movement of the adjustment element are essentially parallel.

19. The valve according to claim 1, wherein a solenoid is provided as drive, and wherein the solenoid has a coil that can be electrified by current, an armature supported movably on bearings, and a return spring, and the armature supported movably on bearings can be moved when electrified, in particular against the power of the return spring, and the armature moves the adjustment element or the armature forms the adjustment element.

20. The valve according to claim 1, wherein either an essentially straight or rotation or folding movement of the adjustment element is provided.
